(19) United States
(12) Patent Application Publication
(10) Pub. No.: US 2012/0162186 A1
(43) Pub. Date: Jun. 28, 2012

(54) Electrophoretic Display Apparatus and Method of Controlling the Same

(75) Inventors: Il-Nam Kim, Yongin-City (KR); Won-Sang Park, Yongin-City (KR); Min-Woo Kim, Yongin-City (KR); Soo-Min Baek, Yongin-City (KR); Jae-Kyoung Kim, Yongin-City (KR)

(73) Assignee: SAMSUNG MOBILE DISPLAY CO., LTD., Yongin-City (KR)

(21) Appl. No.: 13/241,583

(22) Filed: Sep. 23, 2011

(30) Foreign Application Priority Data
Dec. 28, 2010 (KR) 10-2010-0137223

(51) Int. Cl. G06F 3/038; G09G 3/34

(52) U.S. Cl. 345/212; 345/107

(57) ABSTRACT

An electrophoretic display apparatus and a method of controlling the same. The electrophoretic display apparatus includes an electrophoretic cell including a lower electrode and in-plane electrodes, wherein the lower electrode and the in-plane electrodes are connected to same data line and receive data voltages in response to other gate signals. According to embodiments of the present invention, the number of channels in a data driving unit may be decreased by a few times.

### CLAIM OF PRIORITY

This application makes reference to, incorporates the same herein, and claims all benefits accruing under 35 U.S.C §119 from an application entitled earlier filed in the Korean Intellectual Property Office on Dec. 28, 2010, and there duly assigned Serial No. 10-2010-0137223 by that Office.

### BACKGROUND OF THE INVENTION

1. Field of the Invention

The present invention relates to an electrophoretic display apparatus and a method of controlling the same.

2.Description of the Related Art

Electrophoretic display apparatuses display input images by using electrophoretic cells. The electrophoretic display apparatuses display images by using movement of charge carriers in a magnetic field and are next-generation display apparatuses having wide viewing angles, easy readability, and low power consumption. Also, the electrophoretic display apparatuses are widely used in various fields such as e-books, e-paper, and the like and are widely being studied.

### SUMMARY OF THE INVENTION

The present invention provides an electrophoretic display apparatus including a lower electrode and an in-plane electrode for reducing the number of data channels.

According to an aspect of the present invention, there is provided an electrophoretic display apparatus, the apparatus including: a pixel unit having pixels each comprising an electrophoretic cell; a gate driving unit for generating first and second gate signals and outputting the generated first and second gate signals to the pixels through first and second gate lines, respectively; and a data driving unit for generating data voltages and outputting the data voltages to the pixels through data lines, wherein the electrophoretic cell includes: an upper layer; a lower layer facing the upper layer; an upper electrode disposed on the upper layer; and a lower electrode and at least one in-plane electrode disposed on the lower layer, wherein the lower electrode and the at least one in-plane electrode are connected to the same data line, the data voltage is applied to the at least one in-plane electrode in response to the first gate signal, and the data voltage is applied to the lower electrode in response to the second gate signal.

The pixels may each include: a first transistor, in which a first terminal thereof is connected to the data line, a second terminal thereof is connected to the at least one in-plane electrode, and a gate terminal thereof is connected to the first gate line; and a second transistor, in which a first terminal thereof is connected to the lower electrode, a second terminal thereof is connected to the data line, and a gate terminal thereof is connected to the second gate line.

The pixels may further include: a first storage capacitor connected between the second terminal of the first transistor and a ground line; and a second storage capacitor connected between the first terminal of the second transistor and the ground line.

The at least one in-plane electrode may include a first in-plane electrode and a second in-plane electrode disposed at both sides of the lower electrode.

The at least one in-plane electrode may have a narrower area than the lower electrode.

The first gate signal and the second gate signal may have a gate-on level during each different time period, and the data driving unit may output a data voltage corresponding to the at least one in-plane electrode while the first gate signal has the gate-on level and outputs a data voltage corresponding to the lower electrode while the second gate signal has the gate-on level.

The electrophoretic cell may include: a dispersion medium filled between the upper layer and the lower layer; and electrophoretic particles that move in the dispersion medium.

The pixels may each include a plurality of sub-pixels, the electrophoretic cell may correspond to the sub-pixel, the dispersion medium may have a color corresponding to a color component of the sub-pixel, the electrophoretic particles may have a first background color, and the lower layer may have a second background color.

The pixels may each include a plurality of sub-pixels, the electrophoretic cell may correspond to the sub-pixel, the dispersion medium may have a first background color, the electrophoretic particles may have a color corresponding to a color component of the sub-pixel, and the lower layer may have a second background color.

The color component of the sub-pixel may be red, green, or blue, the first background color may be white or black, and the second background color may be white or black that is different from the first background color.

The color component of the sub-pixel may be red, green, blue, or white, the first background color may be white or black, and the second background color may be white or black that is different from the first background color.

The pixels may each include a plurality of sub-pixels, and at least two of the sub-pixels included in one pixel may be connected to the same data line and be connected to each different first gate line and each different second gate line.

The pixels may each include a plurality of sub-pixels, and at least two of the sub-pixels included in one pixel may be connected to the same first gate line and the same second gate line and be connected to each different data line.

According to another aspect of the present invention, there is provided a method of controlling an electrophoretic display apparatus, wherein pixels of the electrophoretic display apparatus each includes an electrophoretic cell comprising: an upper electrode disposed on an upper layer; and a lower electrode and at least one in-plane electrode disposed on a lower layer, wherein the lower electrode and the at least one in-plane electrode are connected to the same data line, the pixels are connected to a first gate line, which transmits a first gate signal, and a second gate line, which transmits a second gate signal, the method including: applying data voltages to the at least one in-plane electrode while the first gate signal has the gate-on level; applying the data voltage to the lower electrode while the second gate signal has the gate-on level; and maintaining voltage levels of the lower electrode and the at least one in-plane electrode.

The pixels may each include a plurality of sub-pixels, and at least two of the sub-pixels included in one pixel may share the data line, may be connected to each different first gate line and each different second gate line, and the at least two sub-pixels that share the data line may be driven by using a time division method.

The pixels may each include a plurality of sub-pixels, and at least two of the sub-pixels included in one pixel may be connected to the same first gate line, the same second gate line, and each different data line, in the applying of the data voltages to the at least one in-plane electrode, the data voltages may each be applied to the at least one in-plane electrode of the at least two sub-pixels while the first gate signal has the gate-on level, and in the applying of the data voltage to the lower electrode, the data voltage may be applied to the lower electrode of the at least two sub-pixels while the second gate signal has the gate-on level.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 schematically illustrates an electrophoretic display apparatus according to an embodiment of the present invention;

FIG. 2 is a cross-sectional view of an electrophoretic cell according to an embodiment of the present invention;

FIGS. 3 through 5 are cross-sectional views illustrating operation of the electrophoretic cell of FIG. 2 according to embodiments of the present invention;

FIG. 6 is a circuit diagram illustrating connection between in-plane electrodes and a lower electrode and between gate lines and a data line, according to an embodiment of the present invention;

FIG. 7 is a timing diagram illustrating operation of the electrophoretic display apparatus of FIG. 1, according to an embodiment of the present invention;

FIG. 8 is a circuit diagram illustrating connection between sub-pixels according to an embodiment of the present invention;

FIG. 9 is a circuit diagram illustrating connection between sub-pixels according to another embodiment of the present invention;

FIG. 10 is a circuit diagram illustrating connection between sub-pixels according to another embodiment of the present invention; and

FIG. 11 is a circuit diagram illustrating connection between sub-pixels according to another embodiment of the present invention.

### DETAILED DESCRIPTION OF THE INVENTION

The exemplary embodiments of the present invention will be described in detail with reference to the accompanying drawings and description of the drawings so as to fully understand advantages and objectives of the present invention. The present invention may, however, be embodied in many different forms and should not be construed as being limited to the embodiments set forth herein; rather, these embodiments are provided so that this disclosure will be thorough and complete, and will fully convey the concept of the invention to those skilled in the art. The description and the drawings are for the purpose of describing exemplary embodiments and detailed descriptions that may be easily realized by one of ordinary skill in the art may be omitted.

It will be understood that when an element, such as a layer, a region, or a substrate, is referred to as being “on,” “connected to” or “coupled to” another element, it may be directly on, connected or coupled to the other element or intervening elements may be present.

It will be understood that when an element is referred to as being “connected to” or “coupled to” another element, it may be directly connected or coupled to the other element or intervening elements may be present.

In contrast, when an element is referred to as being “directly connected to” or “directly coupled to” another element, there are no intervening elements present. Like reference numerals refer to like elements throughout. As used herein, the term “and/or” includes any and all combinations of one or more of the associated listed items.

It will be understood that, although the terms first, second, third, etc., may be used herein to describe various elements, components, and/or sections, these elements, components, and/or sections should not be limited by these terms. These terms are only used to distinguish one element, component, or section from another element, component, or section. Thus, a first element, component, or section discussed below could be termed a second element, component, or section without departing from the teachings of exemplary embodiments.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising” when used in this specification, specify the presence of stated elements, steps, operations, and/or components, but do not preclude the presence or addition of one or more other elements, steps, operations, components, and/or groups thereof.

Unless defined differently, all terms used in the description including technical and scientific terms have the same meaning as generally understood by those skilled in the art. Terms as defined in a commonly used dictionary should be construed as having the same meaning as in an associated technical context, and unless defined apparently in the description, the terms are not ideally or excessively construed as having formal meaning

Hereinafter, one or more embodiments of the present invention will be described more fully with reference to the accompanying drawings.

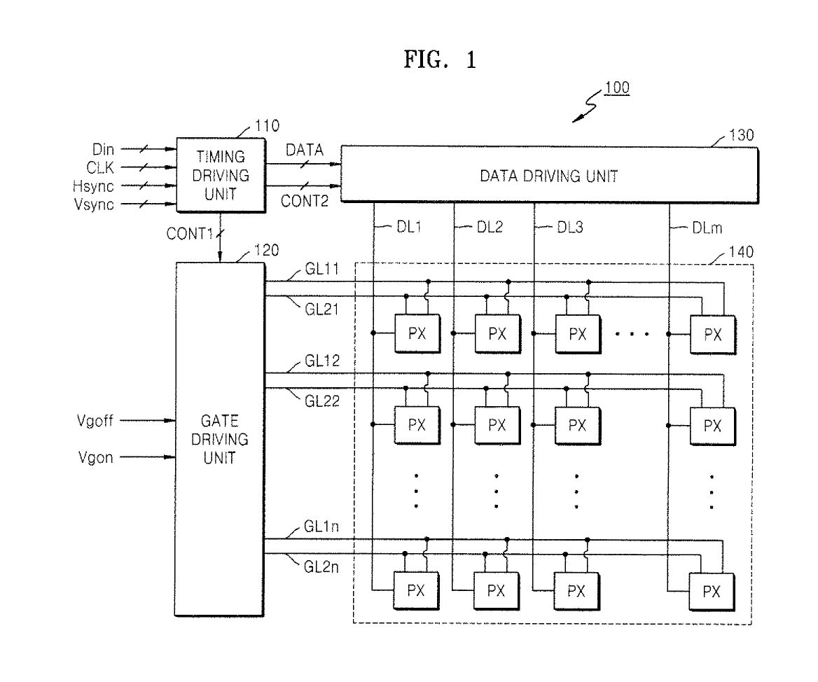

FIG. 1 schematically illustrates an electrophoretic display apparatus 100 according to an embodiment of the present invention. The electrophoretic display apparatus 100 according to the current embodiment of the present invention includes a timing driving unit 110, a gate driving unit 120, a data driving unit 130, and a pixel unit 140. The pixel unit 140 includes a plurality of pixels PX, wherein the pixels PX each include an electrophoretic cell 200.

The timing driving unit 110 receives an input image Din, a clock signal CLK, a horizontal synchronization signal Hsync, and a vertical synchronization signal Vsync, outputs a gate driving control signal CONT1 to the gate driving unit 120, and outputs a data signal DATA and a data driving control signal CONT2 to the data driving unit 130.

The gate driving unit 120 receives the gate driving control signal CONT1, a gate-on level voltage Vgon, and a gate-off level voltage Vgoff and generates a first gate signal and a second gate signal. Also, the gate driving unit 120 transmits the first gate signal to each pixel PX through first gate lines GL11 through GL1n and the second gate signal to each pixel PX through second gate lines GL21 through GL2n.

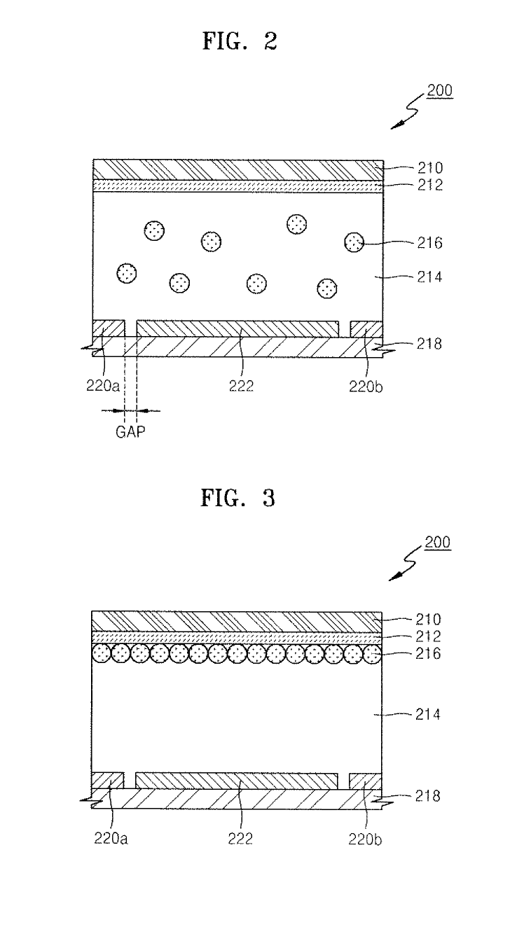

As shown in FIG. 2, each pixel PX includes a electrophoretic cell 200 having a lower electrode and at least one in-plane electrode on a lower layer and receives a data voltage according to the first and second gate signals. The structure of the electrophoretic cell 200 will be described in detail below.

Referrring again to FIG. 1, the data driving unit 130 receives the data signal DATA and the data driving control signal CONT2 and generates data voltages. Also, the data driving unit 130 transmits the data voltages to each pixel PX through data lines DL1 through DLm. According to embodiments of the present invention, the data driving unit 130 generates data voltages applied to the lower electrode and the at least one in-plane electrode in each pixel PX. When the first gate signal or the second gate signal has the gate-on level voltage Vgon, the data driving unit 130 outputs the data voltages to the lower electrode and the at least one in-plane electrode using a time division method. Output timing of the data voltages is described in detail below.

The pixel unit 140 includes the plurality of pixels PX. The plurality of pixels PX are arranged in a n*m matrix form and may be disposed near points where the data lines DL1 through DLm cross the first and second gate lines GL 11 through GL1 and GL21 through GL2n. Each pixel PX is connected to a first gate line (one of the first gate lines GL11 through GL1), a second gate line (one of the second gate lines GL21 through GL2n) corresponding to the first gate line, and a data line (one of the data lines DL1 through DLm). Also, the pixels PX according to embodiments of the present invention each include the electrophoretic cell 200.

FIG. 2 is a cross-sectional view of the electrophoretic cell 200 according to an embodiment of the present invention.

The electrophoretic cell 200 is formed between an upper layer 210 and a lower layer 218. The upper layer 210 includes an upper electrode 212 and the lower layer 218 includes in-plane electrodes 220a and 220b and a lower electrode 222. In the electrophoretic cell 200, a dispersion medium 214 is filled between the upper layer 210 and the lower layer 218 and electrophoretic particles 216 are included in the dispersion medium 214.

The upper layer 210 is formed of a transparent material, for example, a transparent glass or a flexible transparent film. The upper layer 210 includes the upper electrode 212, which is transparent. The upper electrode 212 may be formed of, for example, ITO, IZO, ZnO, or In₂O₃.

The lower layer 218 includes the in-plane electrodes 220a and 220b and the lower electrode 222. The lower electrode 222 is disposed at the center of the lower layer 218, has a wider area than the in-plane electrodes 220a and 220b, and is formed to be spaced apart from the in-plane electrodes 220a and 220b by gaps. The in-plane electrodes 220a and 220b may be disposed at the left side and the right side of the lower electrode 222, respectively, and may each have a narrower area than the lower electrode 222. The lower electrode 222 and the in-plane electrodes 220a and 220b are formed to be electrically insulated from each other. The lower electrode 222 receives a data voltage in response to the second gate signal and the in-plane electrodes 220a and 220b receive a data voltage in response to the first gate signal. In FIG. 2, two in-plane electrodes 220a and 220b are illustrated. However, the present invention is not limited thereto and the number of in-plane electrodes may vary.

The dispersion medium 214 includes the electrophoretic particles 216. The electrophoretic particles 216 move in a magnetic field by electophoresis and are organic or inorganic particles that are electrically charged with a predetermined electric charge. For convenience of description, it is assumed in this specification that the electrophoretic particles 216 are charged with a positive charge. However, the polarity of the electrophoretic particles 216 is not limited thereto.

According to an embodiment of the present invention, each pixel PX includes a plurality of sub-pixels having a plurality of color components. For example, each pixel PX may include three sub-pixels such as a red pixel R, a green pixel G, and a blue pixel B. As another example, each pixel PX may include four sub-pixels such as a red pixel R, a green pixel G, a blue pixel B, and a white pixel W. In this case, the electrophoretic cell 200 may correspond to a color corresponding to each of the plurality of sub-pixels.

As such, when the electrophoretic cell 200 has one of the color components of the sub-pixels, the dispersion medium 214 may have a color of a color component corresponding to a sub-pixel, the electrophoretic particles 216 may have a first background color, and the lower layer 218 may have a second background color. In this regard, the in-plane electrodes 220a and 220b and the lower electrode 222 may be transparent electrodes. The first background color may be white or black and the second background color may be a color other than the first background color among white and black. That is, the first background color may be white and the second background color may be black. As another example, the first background color may be black and the second background color maybe white. Also, the in-plane electrodes 220a and 220b and the lower electrode 222 may have the second background color and the lower layer 218 may not be particularly restricted.

According to another embodiment of the present invention, the dispersion medium 214 may have the first background color, the electrophoretic particles 216 may have a color of a color component corresponding to a sub-pixel, and the lower layer 218 may have the second background color. Here, the in-plane electrodes 220a and 220b and the lower electrode 222 may be transparent electrodes. The first background color may be white or black and the second background color may be a color other than the first background color among white and black. Also, the in-plane electrodes 220a and 220b and the lower electrode 222 may have the second background color and the lower layer 218 may not be particularly restricted.

For convenience of description, in this specification, the dispersion medium 214 has one of red, green, blue, and white colors, that is, a color corresponding to a sub-pixel, the electrophoretic particles 216 are white, and the lower layer 218 is black.

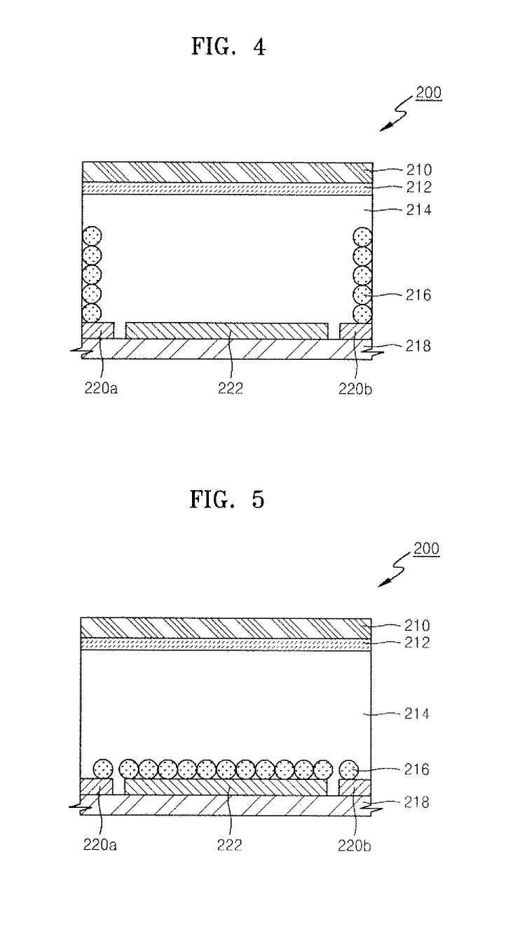

FIGS. 3 through 5 are cross-sectional views illustrating operation of the electrophoretic cell 200 of FIG. 2 according to embodiments of the present invention.

According to the embodiments of the present invention, the electrophoretic particles 216 may move in upper and lower directions according to polarities of the upper electrode 212 and the lower electrode 222 and the electrophoretic particles 216 may move in a horizontal direction according to polarities of the in-plane electrodes 220a and 220b and the lower electrode 222.

In FIG. 3, a negative voltage is applied to the upper electrode 212 and a positive voltage is applied to the in-plane electrodes 220a and 220b and the lower electrode 222. Referring to FIG. 3, the electrophoretic particles 216 having positive polarities move toward the upper layer 210 so that an observer may view the color of the electrophoretic particles 216, that is, white.

In FIG. 4, a positive voltage is applied to the upper electrode 212 and the lower electrode 222 and a negative voltage is applied to the in-plane electrodes 220a and 220b. Referring to FIG. 4, the electrophoretic particles 216 having positive polarities move toward the in-plane electrodes 220a and 220b so that an observer may view the color of the lower layer 218, that is, black.

In FIG. 5, a positive voltage is applied to the upper electrode 212 and a negative voltage is applied to the in-plane electrodes 220a and 220b and the lower electrode 222. Referring to FIG. 5, the electrophoretic particles 216 having positive polarities move toward the in-plane electrodes 220a and 220b and the lower electrode 222 so that an observer may view the color of the dispersion medium 214. That is, when the dispersion medium 214 is red in color, an observer may view red. When the dispersion medium 214 is green in color, an observer may view green. When the dispersion medium 214 is blue in color, an observer may view blue. When the dispersion medium 214 is white in color, an observer may view white.

The electrophoretic display apparatus 100 according to the embodiment of the present invention may display an input image by adjusting a color represented in each sub-pixel, as described with reference to FIGS. 3 through 5.

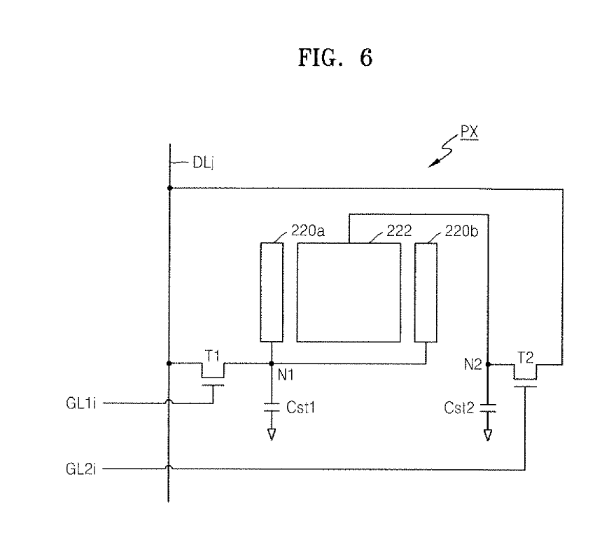

FIG. 6 is a circuit diagram illustrating connection between the in-plane electrodes 220a and 220b and the lower electrode 222 and between first and second gate lines GL1i and GL2i and a data line DLj according to an embodiment of the present invention.

The in-plane electrodes 220a and 220b are connected to the first gate line GL1i and the lower electrode 222 is connected to the second gate line GL2i. The pixel PX may include a first transistor T1, a second transistor T2, a first storage capacitor Cst1 and a second storage capacitor Cst2 connected to the electrophoretic cell.

More specifically, referring to FIG. 6, a first terminal of the first transistor T1 is connected to the data line DLj and a second terminal of the first transistor T1 is connected to a node N1 to which the in-plane electrodes 220a and 220b are connected, and a gate terminal of the first transistor T1 is connected to the first gate line GL1i. Also, the first storage capacitor Cst1 may be connected between the node N1, to which the in-plane electrodes 220a and 220b are connected, and a ground line. A first terminal of the second transistor T2 is connected to a node N2 to which the lower electrode 222 is connected, a second terminal of the second transistor T2 is connected to the data line DLj, and a gate terminal of the second transistor T2 is connected to the second gate line GL2i. Also, the second storage capacitor Cst2 may be connected between the node N2 and the ground line.

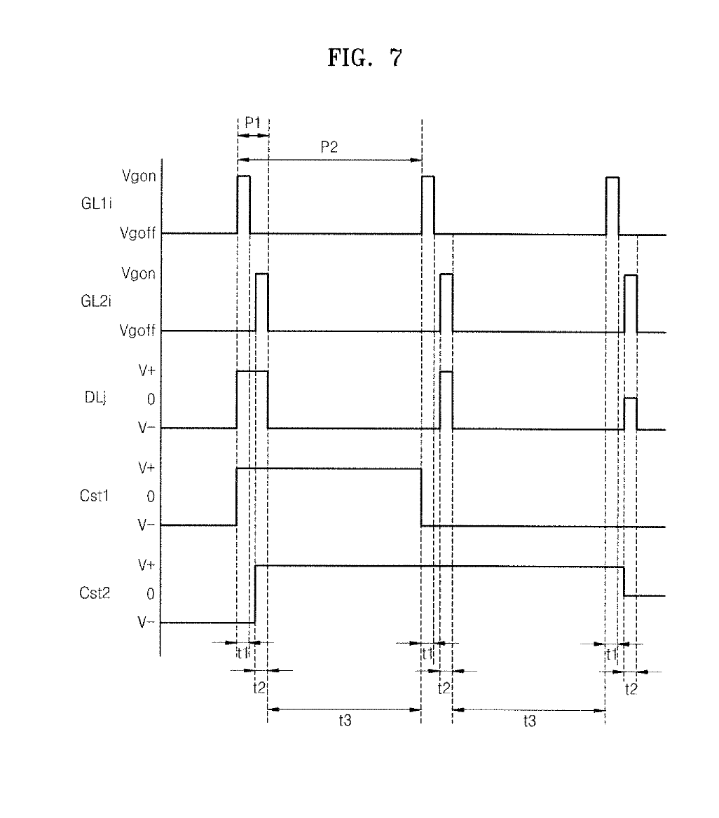

FIG. 7 is a timing diagram illustrating operation of the electrophoretic display apparatus 100 of FIG. 1, according to an embodiment of the present invention. The operation of the electrophoretic display apparatus 100 is described with reference to FIGS. 6 and 7.

The electrophoretic display apparatus 100 according to the embodiment of the present invention has a storage period P1, in which the first storage capacitor Cst1 and the second storage capacitor Cst2 are charged, and a display period P2, in which the electrophoretic particles 216 move in the dispersion medium 214 and an input image is displayed.

According to embodiments of the present invention, the first gate signal and the second gate signal has the gate-on level voltage Vgon with a timing difference therebetween during the storage section P1. More specifically, during a first time t1, where the first gate signal has the gate-on level voltage Vgon, the first transistor T1 is turned on, a voltage of the data line DLj, that is, a data voltage, is applied to the node N1 and the first storage capacitor Cst1 is charged to a voltage level of the data line Dlj.

Then, during a second time t2, where the second gate signal has the gate-on level voltage Vgon, the second transistor T2 is turned on, a voltage of the data line DLj is applied to the node N2, and the second storage capacitor Cst2 is charged to a voltage level of the data line DLj.

When the first gate signal has the gate-on level voltage Vgon, the data driving unit 130 outputs a data voltage to be applied to the in-plane electrodes 220a and 220b. When the second gate signal has the gate-on level voltage Vgon, the data driving unit 130 outputs a data voltage to be applied to the lower electrode 222.

In FIG. 7, the first gate signal has the gate-on level voltage Vgon, then, the second gate signal has the gate-on level voltage Vgon, and a data voltage is firstly applied to the in-plane electrodes 220a and 220b, and then, a data voltage is applied to the lower electrode 222. However, the present invention is not limited thereto and the order of applying a data voltage is not limited to the in-plane electrodes 220a and 220b and the lower electrode 222. That is, the data voltage may be firstly applied to the lower electrode 222 and then to the in-plane electrodes 220a and 220b. In this case, the second gate signal firstly has the gate-on level voltage Vgon and then the first gate signal has the gate-on level voltage Vgon.

Also, in FIG. 7, there is a time interval between the first time t1 and the second time t2; however, there may not be a time interval between the first time t1 and the second time t2.

When the data voltage is applied to the first storage capacitor Cst1 and the second storage capacitor Cst2, the in-plane electrodes 220a and 220b and the lower electrode 222 are maintained at a data voltage level during a third time t3.

In the electrophoretic display apparatus 100, since mobility of the electrophoretic particles 216 is very low in the dispersion medium 214 and thus a time interval of the display period P2 is relatively longer than that of the storage period P1. For example, the length of the storage period P1 may be few microseconds usec and the length of the display period P2 may be few milliseconds msec. Accordingly, in the electrophoretic display apparatus 100, the in-plane electrodes 220a and 220b and the lower electrode 222 are driven using a time division method so that although a data voltage is applied to the in-plane electrodes 220a and 220b and the lower electrode 222 with a timing difference therebetween, the response speed of the electrophoretic particles 216 is very slow and thus a gray scale representation may not be significantly affected. Moreover, the same data voltage needs to be applied to the upper electrode 212, the in-plane electrodes 220a and 220b, and the lower electrode 222 in order to represent a gray scale during several tens of successive frames in the electrophoretic display apparatus 100. Thus, there is a difference between the initial few microseconds and the display period P2 by tens of thousands of times and thus gray scale representation may not be affected. Accordingly, in the embodiments of the present invention, the number of channels of the data driving unit 130 may be reduced by few times without deterioration of a gray scale representation. In general, the data driving unit 130 is more expensive than the gate driving unit 120 and thus a manufacturing cost of the electrophoretic display apparatus 100 may be reduced.

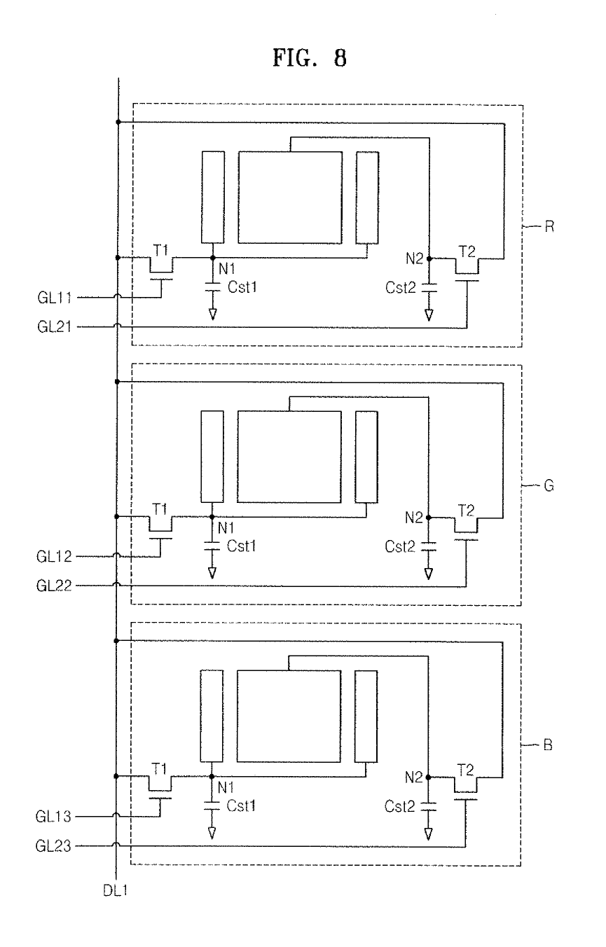

FIG. 8 is a circuit diagram illustrating connection between sub-pixels according to the present invention. FIGS. 8 through 11 illustrate a pixel PX disposed at a first row and a first column.

According to an embodiment of the present invention, each pixel PX includes a red sub-pixel R, a green sub-pixel G, and a blue sub-pixel B, and the sub-pixels R, G, and B included in one pixel PX may share a data line DL1. In this case, the red sub-pixel R, the green sub-pixel G, and the blue sub-pixel B are connected to each different gate line. In FIG. 8, the red sub-pixel R may be connected to the first gate line GL11 and the second gate line GL21 both at the first row, the green sub-pixel G may be connected to the first gate line GL12 and the second gate line GL22 both at the second row, and the blue sub-pixel B may be connected to the first gate line GL13 and the second gate line GL23 both at the third row.

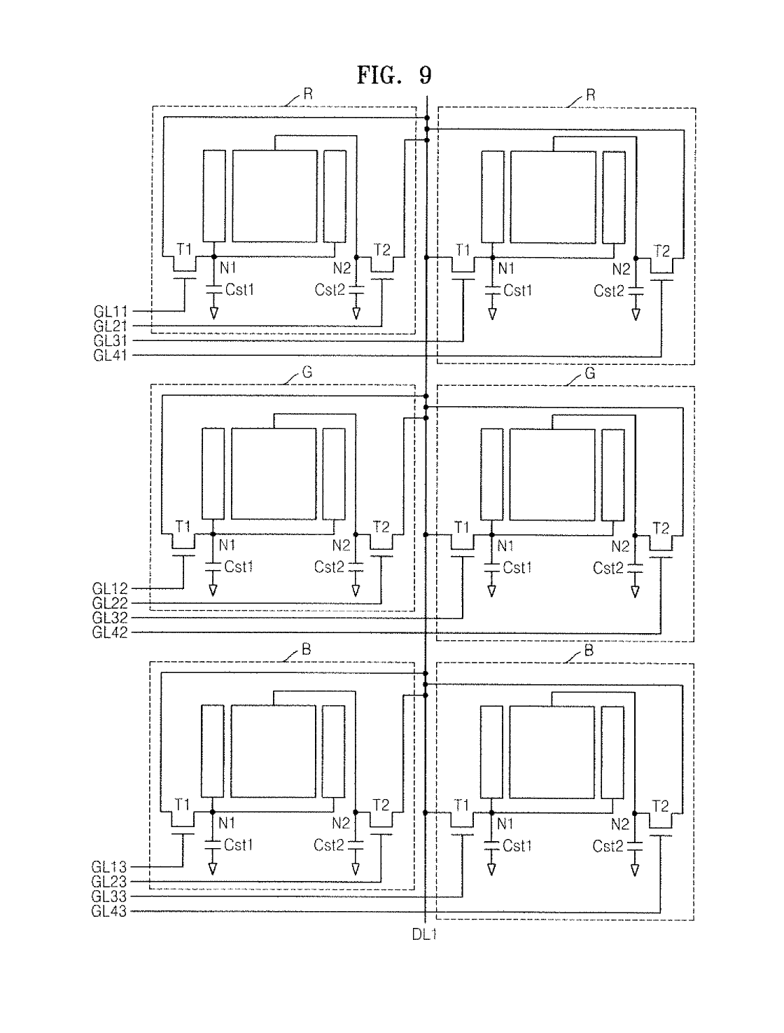

FIG. 9 is a circuit diagram illustrating connection between sub-pixels according to another embodiment of the present invention.

According to the current embodiment of the present invention, the pixels PX each including a red sub-pixel R, a green sub-pixel G, and a blue sub-pixel B may share the data line DL1 with at least one pixel PX of an adjacent column. In this case, the pixels PX which share the data line DL1 are connected to each different gate line. As illustrated in FIG. 9, when the sub-pixels that are adjacent to each other at the first column and the second column share the data line DL1, the red sub-pixel Rat the first column is connected to the gate lines GL11 and GL21 and the red sub-pixel R at the second column is connected to the gate lines GL31 and GL41. In this case, the gate lines GL11, GL21, GL31, and GL41 are driven by using a time division method and the data driving unit sequentially outputs the data voltage to the in-plane electrodes and the lower electrode of each sub-pixel according to order that the gate-on level voltage Vgon is applied to the gate lines.

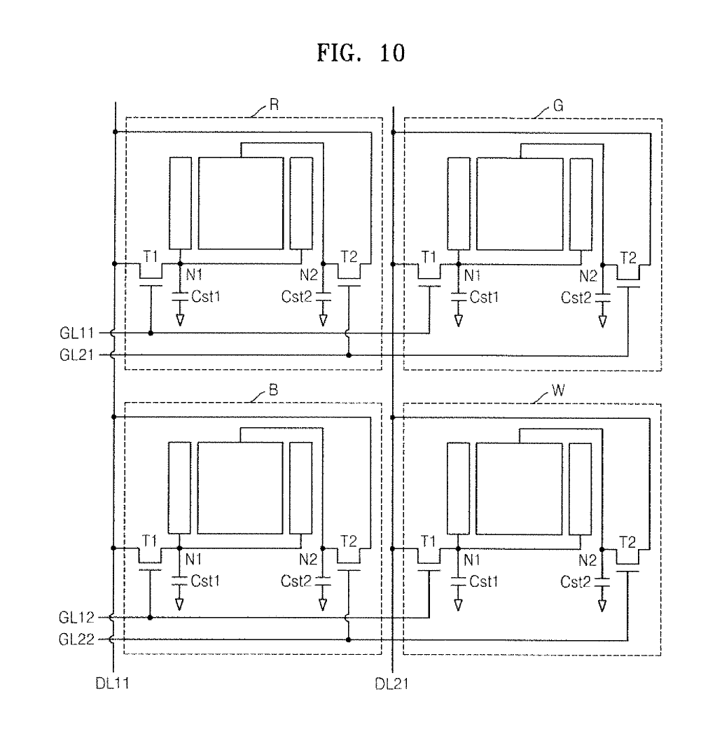

FIG. 10 is a circuit diagram illustrating connection between sub-pixels according to another embodiment of the present invention.

According to the current embodiment of the present invention, each pixel PX includes a red sub-pixel R, a green sub-pixel G, a blue sub-pixel B, and a white sub-pixel W, wherein two of the sub-pixels R, G, B, and W included in one pixel PX share a first data line DL11 and another two may share a second data line DL21. In FIG. 10, the red sub-pixel R and the blue sub-pixel B are connected to the first data line DL11 and the green sub-pixel G and the white sub-pixel W are connected to the second data line DL21. As illustrated in FIG. 10, the red sub-pixel R and the green sub-pixel G that are adjacent to each other are connected to each different data line, that is, the data lines DL11 and DL21, respectively, and connected to the first and second gate lines that are same as each other, that is, the gate lines GL11 and GL22. Also, the blue sub-pixel B and the white sub-pixel W that are adjacent to each other are connected to each different data line, that is, the data lines DL11 and DL21, respectively, and are connected to the first and second gate lines that are same as each other, that is, the gate lines GL11 and GL22. In this case, the gate lines GL11, GL21, GL12, and GL22 are driven by using time division method and the data driving unit sequentially outputs the data voltage to the in-plane electrodes and the lower electrode of each sub-pixel according to order that the gate-on level voltage Vgon is applied to the gate lines.

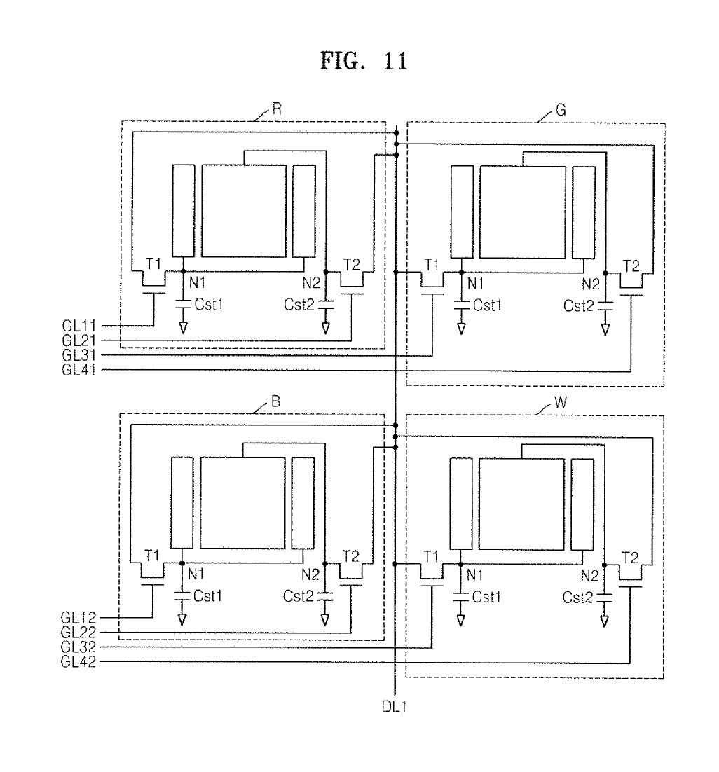

FIG. 11 is a circuit diagram illustrating connection between sub-pixels according to another embodiment of the present invention.

According to the current embodiment of the present invention, in the pixel PX including a red sub-pixel R, a green sub-pixel G, a blue sub-pixel B, and a white sub-pixel W, four sub-pixels included in one pixel PX may share one data line DLL In this case, four sub-pixels R, G, B, and W are connected to the first and second gate lines that are different from each other. That is, as illustrated in FIG. 11, the red sub-pixel R is connected to the gate lines GL11 and GL21, the green sub-pixel G is connected to the gate lines GL31 and GL41, the blue sub-pixel B is connected to the gate lines GL12 and GL22, and the white sub-pixel W is connected to the gate lines GL32 and GL42. In this case, the gate lines GL11, GL21, GL31, GL41, GL12, GL22, GL32, and GL42 are driven by using a time division method and the data driving unit sequentially outputs the data voltage to the in-plane electrodes and the lower electrode of each sub-pixel according to an order that the gate-on level voltage Vgon is applied to the gate lines.

In this specification, the in-plane electrodes 220a and 220b and the lower electrode 222 are mainly described. The upper electrode 212 may be realized by using various methods, for example, any one of active matrix and passive matrix methods or combinations thereof. The present invention is not limited to the structure or controlling method of the upper electrode 212.

According to one or more embodiments of the present invention, the number of data channels, which are expensive, may be reduced in the electrophoretic display apparatus including the lower electrode and the in-plane electrodes and thus a manufacturing cost of the electrophoretic display apparatus may be significantly decreased.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electrophoretic display apparatus, the apparatus comprising:
a pixel unit having pixels each comprising an electrophoretic cell;
a gate driving unit for generating first and second gate signals and outputting
the generated first and second gate signals to the pixels through first and second gate lines, respectively; and
a data driving unit for generating data voltages and outputting the data voltages to the pixels through data lines, wherein the electrophoretic cell comprises: an upper layer; a lower layer facing the upper layer; an upper electrode disposed on the upper layer; and a lower electrode and at least one in-plane electrode disposed on the lower layer, wherein the lower electrode and the at least one in-plane electrode are connected to the same data line, the data voltage is applied to the at least one in-plane electrode in response to the first gate signal, and the data voltage is applied to the lower electrode in response to the second gate signal.

2. The electrophoretic display apparatus of claim 1, wherein the pixels each comprise: a first transistor, in which a first terminal thereof is connected to the data line, a second terminal thereof is connected to the at least one in-plane electrode, and a gate terminal thereof is connected to the first gate line; and a second transistor, in which a first terminal thereof is connected to the lower electrode, a second terminal thereof is connected to the data line, and a gate terminal thereof is connected to the second gate line.

3. The electrophoretic display apparatus of claim 2, wherein the pixels further comprise:
a first storage capacitor connected between the second terminal of the first transistor and a ground line; and a second storage capacitor connected between the first terminal of the second transistor and the ground line.

4. The electrophoretic display apparatus of claim 1, wherein the at least one in-plane electrode comprises a first in-plane electrode and a second in-plane electrode disposed at both sides of the lower electrode.

5. The electrophoretic display apparatus of claim 1, wherein the at least one in-plane electrode has a narrower area than the lower electrode.

6. The electrophoretic display apparatus of claim 1, wherein the first gate signal and the second gate signal have a gate-on level during each different time period, and the data driving unit outputs a data voltage corresponding to the at least one in-plane electrode while the first gate signal has the gate-on level and outputs a data voltage corresponding to the lower electrode while the second gate signal has the gate-on level.

7. The electrophoretic display apparatus of claim 1, wherein the electrophoretic cell comprises: a dispersion medium filled between the upper layer and the lower layer; and electrophoretic particles that move in the dispersion medium.

8. The electrophoretic display apparatus of claim 7, wherein the pixels each comprise a plurality of sub-pixels, the electrophoretic cell corresponds to the sub-pixel, the dispersion medium has a color corresponding to a color component of the sub-pixel, the electrophoretic particles have a first background color, and the lower layer has a second background color.

9. The electrophoretic display apparatus of claim 7, wherein the pixels each comprise a plurality of sub-pixels, the electrophoretic cell corresponds to the sub-pixel, the dispersion medium has a first background color, the electrophoretic particles have a color corresponding to a color component of the sub-pixel, and the lower layer has a second background color.

10. The electrophoretic display apparatus of claim 8, wherein the color component of the sub-pixel is red, green, or blue, the first background color is white or black, and the second background color is white or black that is different from the first background color.

11. The electrophoretic display apparatus of claim 9, wherein the color component of the sub-pixel is red, green, or blue, the first background color is white or black, and the second background color is white or black that is different from the first background color.

12. The electrophoretic display apparatus of claim 8, wherein the color component of the sub-pixel is red, green, blue, or white, the first background color is white or black, and the second background color is white or black that is different from the first background color.

13. The electrophoretic display apparatus of claim 9, wherein the color component of the sub-pixel is red, green, blue, or white, the first background color is white or black, and the second background color is white or black that is different from the first background color.

14. The electrophoretic display apparatus of claim 1, wherein the pixels each comprise a plurality of sub-pixels, and at least two of the sub-pixels included in one pixel are connected to the same data line and are connected to each different first gate line and each different second gate line.

15. The electrophoretic display apparatus of claim 1, wherein the pixels each comprise a plurality of sub-pixels, and at least two of the sub-pixels included in one pixel are connected to the same first gate line and the same second gate line and are connected to each different data line.

16. A method of controlling an electrophoretic display apparatus, wherein pixels of the electrophoretic display apparatus each comprise an electrophoretic cell comprising: an upper electrode disposed on an upper layer; and a lower electrode and at least one in-plane electrode disposed on a lower layer, wherein the lower electrode and the at least one in-plane electrode are connected to the same data line, the pixels are connected to a first gate line, which transmits a first gate signal, and a second gate line, which transmits a second gate signal, the method comprising:
applying a data voltage to the at least one in-plane electrode while the first gate signal has the gate-on level;
applying the data voltage to the lower electrode while the second gate signal has the gate-on level; and
maintaining voltage levels of the lower electrode and the at least one in-plane electrode.

17. The method of claim 16, wherein the pixels each comprise a plurality of sub-pixels, and at least two of the sub-pixels included in one pixel share the data line, are connected to each different first gate line and each different second gate line, and the at least two sub-pixels that share the data line are driven by using a time division method.

18. The method of claim 16, wherein the pixels each comprise a plurality of sub-pixels, and at least two of the sub-pixels included in one pixel are connected to the same first gate line, the same second gate line, and each different data line, in the applying of the data voltage to the at least one in-plane electrode, the data voltage is applied to the at least one in-plane electrode of the at least two sub-pixels while the first gate signal has the gate-on level, and in the applying of the data voltage to the lower electrode, the data voltage is applied to the lower electrode of the at least two sub-pixels while the second gate signal has the gate-on level.
